(19) United States
(12) Patent Application Publication
(10) Pub. No.: US 2023/0004835 A1
(43) Pub. Date: Jan. 5, 2023

(54) MACHINE-LEARNING-BASED TECHNIQUES FOR DETERMINING RESPONSE TEAM PREDICTIONS FOR INCIDENT ALERTS IN A COMPLEX PLATFORM

(71) Applicants: ATLASSIAN PTY LTD, Sydney (AU); ATLASSIAN, INC., San Franciscos, CA (US)

(72) Inventors: Mayank SAWHNEY, Hyderabad (IN); Shashank Prasad RAO, Noida (IN); Akshar PRASAD, Bengaluru (IN); Saloni KHANDELWAL, Bangalore (IN)

(21) Appl. No.: 17/454,838

(22) Filed: Nov. 15, 2021

Related U.S. Application Data
(60) Provisional application No. 63/202,924, filed on Jun. 30, 2021.

(51) Int. Cl. G06N 5/04; G08B 21/18

(52) U.S. Cl. CPC G06N 5/04; G08B 21/182

(57) ABSTRACT

Various embodiments of the present invention provide methods, apparatuses, systems, computing devices, and/or the like that are configured accurately and programmatically train a responder prediction machine learning model for generating response team predictions based on the systematic collection of one or more responder prediction training corpuses comprising one or more alert related datasets in a responder prediction server system. For example, the responder prediction server system may extract one or more alert attributes for each of the one or more alert related datasets for training one or more responder prediction machine learning models and/or one or more prioritization machine learning models. The responder prediction machine learning model and prioritization machine learning models may process one or more alerts, in real-time, to generate one or more response team prediction objects for rendering in a response team suggestion interface.

### BACKGROUND

The complexity of enterprise software has matured to a degree that there are now more potential failure points than ever. The impact of an incident can be devastating. Some estimates suggest that major incidents can cost an organization $300,000 per hour that an enterprise software system is down. Applicant has identified many deficiencies and problems associated with existing methods, apparatuses, and systems for generating and transmitting response prediction alerts to initiate responder action to address possible incidents in complex platform. Through applied effort, ingenuity, and innovation, these identified deficiencies and problems have been solved by developing solutions that are embodied in accordance with the embodiments of the present invention, many examples of which are described in detail herein.

### BRIEF SUMMARY

In general, embodiments of the present invention provide methods, apparatuses, systems, computing devices, and/or the like that are configured to effectively and efficiently extract one or more alerts from an alert monitoring service tool assigned to a complex platform; apply a responder prediction machine learning model to determine a response team prediction for each alert; determine, based on each response team prediction, a client identifier set for of the response team prediction; and transmit the response team prediction to a prediction service API.

In accordance with another aspect, a computer-implemented method of training a responder prediction machine learning model for generating response team predictions comprising: collecting alert related datasets originating from one or more alert monitoring service tools over a predetermined time period; extracting alert attributes from the alert related datasets to create a responder prediction training corpus, wherein the alert attributes comprise an alert identifier, a tag identifier, a log identifier, a description identifier, and a responder team identifier; training the responder prediction machine learning model using the responder prediction training corpus; and storing the responder prediction machine learning model following training to a responder prediction model repository, wherein the responder prediction model repository is accessible by a responder prediction service.

In some embodiments, the computer-implemented method may further comprise: collecting second alert related datasets originating from the one or more alert monitoring service tools over a second predetermined time period; extracting second alert attributes from the second alert related datasets to create a second responder prediction training corpus; training the responder prediction machine learning model using the second responder prediction training corpus; and storing the responder prediction machine learning model following training to the responder prediction model repository.

In some embodiments, the computer-implemented method may comprise: receiving one or more alerts from an alert monitoring service tool; and applying, for each of the one or more alerts, a responder prediction machine learning model to determine a response team prediction object for each alert. In some embodiments, the computer-implemented method may comprise applying a score to each response team prediction object of the one or more alerts. In some embodiments, the computer-implemented method may comprise: determining the score of the response team prediction object using at least one of a user input or a closing alert, and wherein the score is calculated by comparing the response team prediction object with at least one of the user input or the closing alert. In some embodiments, the computer-implemented method may comprise training the responder prediction machine learning model in a subsequent stage using the score associated with each response team prediction object of the one or more alerts. In some embodiments, the computer-implemented method is provided, wherein the score is applied to the responder prediction machine learning model to determine one or more future response team prediction objects.

In some embodiments, the computer-implemented method may comprise training a prioritization machine learning model comprising: training the prioritization machine learning model using the responder prediction training corpus, the alert attributes of the responder prediction training corpus further comprising a prioritization weight identifier; and storing the prioritization machine learning model following training to the responder prediction model repository, wherein the responder prediction model repository is accessible by a responder prediction service. In some embodiments, the computer-implemented method may comprise collecting second alert related datasets originating from the one or more alert monitoring service tools over a second predetermined time period; extracting second alert attributes from the second alert related datasets to create a second responder prediction training corpus; training the prioritization machine learning model using the second responder prediction training corpus; and storing the prioritization machine learning model following training to the responder prediction model repository.

In accordance with another aspect, an apparatus for generating a response team prediction associated with one or more alerts, the apparatus comprising at least one processor and at least one memory including program code, the at least one memory and program code configured to, with the processor, cause the apparatus to at least: receive one or more alerts from an alert monitoring service tool; for each of the one or more alerts, apply a responder prediction machine learning model to determine a response team prediction object for each alert; and cause rendering of a response team suggestion interface based on the response team prediction object.

In some embodiments, the apparatus is provided, wherein the response team prediction object is transmitted to a prediction service API that is configured to indicate an alert notification comprising at least one of the response team prediction, a dataset of routing information associated with at least a client identifier set for the response team prediction, or the alert associated with the response team prediction.

In some embodiments, the apparatus is provided, wherein the responder prediction machine learning model comprises a pre-training with an extracted alert related dataset associated with a complex platform. In some embodiments, the apparatus is provided, wherein the extracted alert related dataset comprises data extracted from a predetermined time period.

In some embodiments, the apparatus is provided, wherein the at least one memory and program code configured to, with the processor, cause the apparatus to at least: receive one or more alerts from an alert monitoring service tool; and for each of the one or more alerts, apply a prioritization machine learning model to determine a prioritization weight for each alert. In some embodiments, the apparatus is provided, wherein an operation sequence of processing for the responder prediction machine learning model is applied to the one or more alerts based on the prioritization weight for each of the one or more alerts. In some embodiments, the apparatus is provided, wherein an operation sequence for determining the response team prediction object is applied to the alerts based on the prioritization weight for each alert. In some embodiments, the apparatus is provided, wherein an operation sequence for the rendering of the response team suggestion interface based on the response team prediction object is based on the prioritization weight for each of the one or more alerts used to generate the response team prediction object.

In some embodiments, the apparatus is provided, wherein a score is determined by the response team prediction associated with an alert and at least one of user input or a closing alert. In some embodiments, the apparatus is provided, wherein the score is applied to the responder prediction machine learning model to determine one or more future response team predictions.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example responder prediction server system architecture within which at least some embodiments of the present invention may operate;

FIG. 2 is a block diagram of an example responder prediction server computing device structured in accordance with at least some embodiments of the present invention;

FIG. 3 is a block diagram of an example client computing device structured in accordance with at least some embodiments of the present invention;

FIG. 4 is a flowchart diagram of an example process for training a responder prediction machine-learning model in accordance with at least some embodiments of the present invention;

FIG. 5 is a flowchart diagram of an example process for determining a response team prediction object and rendering a response team suggestion interface based on an alert in accordance with at least some of the embodiments of the present invention;

FIG. 6 is a flowchart diagram of an example process for training a responder prediction machine learning model using a second responder prediction training corpus in accordance with at least some of the embodiments of the present invention;

FIG. 7 is a flowchart diagram of an example process for training a prioritization machine learning model using a responder prediction training corpus in accordance with at least some of the embodiments of the present invention;

FIG. 8 is a flowchart diagram of an example process for training a prioritization machine learning model using a second responder prediction training corpus in accordance with at least some of the embodiments of the present invention;

FIG. 9 is a flowchart diagram of an example process for determining a prioritization weight for an alert in accordance with at least some of the embodiments of the present invention;

FIG. 10 provides an operational example of a response team suggestion interface in accordance with at least some of the embodiments of the present invention;

FIG. 11 provides exemplary training operations performed in accordance with at least some of the embodiments of the present invention; and

FIG. 12 provides exemplary processing operations performed in accordance with at least some of the embodiments of the present invention.

### DETAILED DESCRIPTION OF VARIOUS EMBODIMENTS

Various embodiments of the present invention will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present invention address technical problems associated with generating and transmitting response team predictions for routing incident alerts generated by alert monitoring tools of complex platforms (e.g., monolithic software platforms and/or service-oriented platforms). Modern complex platforms are supported by vast software development and IT teams. Such teams are consistently changing and developing new and varied expertise. Given that large complex platforms can produce over 1,000,000 incident alerts or cautions per day, it is important that such incident alerts are quickly assessed and accurately routed to an appropriate response team.

Various embodiments discussed herein can be utilized by a responder prediction service. The responder prediction service is disposed in communication with an alert monitoring service tool that is configured to identify incident alerts generated by a complex platform. The responder prediction service may extract the alerts generated by the alert monitoring service tool and apply a responder prediction machine learning model to process the alerts to generate a response team prediction. The response team prediction may comprise an alert identifier which may be used by a responder prediction enrichment service to generate a client identifier set associated with an appropriate software development or IT team (e.g., the appropriate responder or response team data) associated with the monolith software platform that is adept at handling the identified alert. The responder prediction service then proceeds to transmit the identified alert to the responder prediction enrichment service, which may in turn transmit the enriched response team prediction to the client devices of the appropriate responder team based on the client identifier set.

The claimed invention is configured to produce response team predictions efficiently and effectively and thereby reduce or eliminate manual routing of alerts to responder teams. The claimed invention is further configured to reduce or eliminate errors in determining appropriate response team(s) and/or in routing alerts to such response teams. Various embodiments discussed herein further reduce the time needed to determine appropriate response teams and thereby reduce the overall time needed for an issue to be detected and resolved. For instance, various embodiments discussed herein may reduce the time needed to determine appropriate response teams to within 300 milliseconds from the incident alert being received from an alert monitoring service tool.

In some embodiments, when detecting incident alerts on a complex platform, various embodiments of the present invention enable: (i) returning relevant response team predictions based on incident alerts extracted from an alert monitoring service tool; (ii) efficient links to response team predictions based on incident alerts, such that proper response team predictions are returned in less time than alternative procedures and means; (iii) integrating response team predictions into a prediction service API; (iv) rendering a response team suggestion interface; and (v) testing responder prediction machine learning models iteratively with feedback, such that the responder prediction machine learning model is updated iteratively throughout its life and throughout the growth cycle of the monolith software platform. In some embodiments, a service-oriented platform may be used by various embodiments of the present invention to enable: (i) returning relevant response team predictions based on incident alerts extracted from an alert monitoring service tool monitoring the service-oriented platform; (ii) efficient links to response team predictions based on incident alerts, such that proper response team predictions are returned in less time than alternative procedures and means; (iii) integrating response team predictions into a prediction service API; (iv) rendering a response team suggestion interface; and (v) testing responder prediction machine learning models iteratively with feedback, such that the responder prediction machine learning model is updated iteratively throughout its life and throughout the growth cycle of the service-oriented platform.

### Definitions

The term “complex platform,” or “application platform,” refer to a software platform comprising one or more types of software applications (e.g., monolithic platform and/or service-oriented platform), which may be described in more detail below.

The terms “monolithic platform,” or “monolithic software platform,” refer to a software application designed to embody a single-tiered architecture in which the front end and back end systems are combined into a single platform. Monolithic software platforms are self-contained in that they can perform each operation needed to complete their intended purpose or function. Such example monolithic platforms may include Micros™ by Atlassian® platform or DynamoDB® by Amazon®.

The term “service-oriented platform” refers to a software application designed to embody a modular programming architecture based on specific service types, wherein the modular programming may comprise existing services combined by user specification in order to create a custom software application. In some embodiments, the services within the modular programming may configure GUI for user interaction with each service in an individual manner without affecting other services within the service-oriented platform.

A service-oriented platform is typically characterized by large networks of interdependent services and microservices that support a myriad of software features and applications. Indeed, some large service-oriented platforms may be comprised of topologies of 1,500 or more interdependent services and microservices. Such service-oriented platforms are nimble, highly configurable, and enable robust collaboration and communication between users at individual levels, team levels, and enterprise levels.

Service-oriented platforms typically include large numbers of software applications. Each software application includes a number of features, with many features (e.g., user authentication features) shared between multiple software applications. Other features are supported only by one associated software application or a defined subset of software applications.

A given service-oriented platform could support hundreds of software applications and hundreds of thousands of features. Those applications and features could be supported by thousands of services and microservices that exist in vast and ever-changing interdependent layers. Adding to this complexity is the fact that at any given time, a great number of software development teams may be constantly, yet unexpectedly, releasing code updates that change various software services, launch new software services, change existing features of existing software applications, add new software applications, add new features to existing software applications, and/or the like. Still further complexity is added by the fact that, at any given time, the configured rules with respect to directing alerts to a response team (e.g., by identifying a response team) may be incorrect or out-of-date, or the response team may comprise response team data that is out-of-date (e.g., team members or team ownership of the response team identified in the response team prediction object has changed). Service-oriented platforms may allow for such changes to be made within one or more applications and features within such applications.

The term “alert monitoring service tool” refers to a software service that is configured to monitor a complex platform (e.g., monolithic software platform and/or service-oriented platform) and detect alerts, cautions, problems, errors, issues, or incidents. An example alert monitoring service tool is Opsgenie® by Atlassian®. Alert monitoring service tools may also generate one or more incident alerts (i.e., alerts) of the complex platform (e.g., monolithic platform and/or service-oriented platform) that may be extracted for application of responder prediction machine learning models. Such example alert monitoring service tools may include SignalFX® by Splunk®, Opsgenie® by Atlassian®, or DynamoDB® by Amazon® in combination with AWS Lambda™ by Amazon®.

The term “alert” refers to a data object that is configured as information, text, and/or other media used to describe the operating functionality of a complex platform (e.g., monolithic platform and/or the service-oriented platform). Such operating functionality may include indicators regarding the complex platform's performance (e.g., whether the complex platform and its functions are running at peak speed or slower than peak speed, if certain functions or capabilities are not running at peak performance or not running at all, etc.). Alert(s) include alert attributes as defined below. Alert(s) may be generated by an alert monitoring service tool and stored in a storage subsystem of the responder prediction server computing device. Alert(s) and/or alert attributes may be configured as a group or corpus of input data objects that are supplied as an input to train at least the responder prediction machine learning model. Alert(s) associated with a complex platform (e.g., monolithic platform and/or service-oriented platform) are also used by a responder prediction machine learning model to generate a response team prediction.

The term “alert related dataset” refers to a collection of alerts and alert related data that are received from one or more alert monitoring services tools over a predetermined time period. Alert related datasets further comprise response team routing data for each alert identified in the alert related dataset. The alert related dataset may be stored in the storage subsystem of the responder prediction server system, such as the responder prediction model repository.

The term “alert attribute” refers to data, text, identifiers, metadata, or other alert related characteristics or features that are extracted from alert related datasets and used to create a responder prediction training corpus as defined below. Alert attributes are extracted from alert related datasets by a responder prediction service as defined below. Example alert attributes include an alert identifier, a tag identifier, a log identifier, a description identifier, and a responder team identifier. Example alert attributes, in some embodiments, may further include a service identifier and a prioritization weight identifier.

The term “alert identifier” refers to one or more items of data by which an alert may be identified within a responder prediction server system. For example, an alert identifier may comprise text string(s), numerical character(s), alphabetical character(s), alphanumeric code(s), ASCII character(s), a pointer, an IP address, a MAC address, a memory address, other unique identifier, or a combination thereof.

The term “responder prediction machine learning model” refers to a machine learning model that is trained and otherwise configured to receive alerts (e.g., incident alerts) of a complex platform and generate response team predictions. The configuration data for a corresponding responder prediction machine learning model is stored on a storage subsystem associated with a responder prediction service. The responder prediction machine learning model may be trained using one or more training corpuses (e.g., a responder prediction training corpus). Once the responder prediction machine learning model has been trained, the responder prediction machine learning model may process one or more alerts generated by an alert monitoring service tool and output a response team prediction to a prediction service API. Such example responder prediction machine learning models may comprise a Naïve Bayes machine learning model which is trained using the Bayes theorem and the assumption that each input variable is independent from the other input variables; a machine learning model trained to cluster the alerts; word embedding using a Long Short-Term Model (LS™) and Natural Language Processor (NLP); word embedding using an LS™, NLP, and a Convolutional Neural Network (CNN); and/or a graph-based model. In some embodiments, a Naïve Bayes machine learning model may be trained to predict the probability of a phrase associated with n-grams, wherein certain phrases may contain a higher probability of being associated with a particular responder team. In some embodiments, a clustering of alerts is based on embedded natural language values for each alert, wherein the alerts and the associated embedded natural language values are similar for specific responder teams such that only one responder team is identified for each of the plurality of alerts within a cluster. In some embodiments, a plurality of Natural Language Processors (NLPs) and an LS™ may be trained to tokenize natural language values of the alert attributes and embed the phrases (e.g., words associated with a responder team) in vectors associated with other similar phrases. In some embodiments, a plurality of NLPs, an LS™, and a sequential CNN may be trained to tokenize the alert attributes using one of a plurality of NLPs which may be associated with specific alert attributes, embedding each natural language processed phrase from the alert attributes within an individual word vector graph for each alert attribute, and using a sequential CNN to concatenate each of the word vector graphs associated with the alert attributes. In some embodiments, a graph-based model may be used on the alert attributes, wherein various responder teams and users within the responder teams may be graphed as nodes and may be connected to alerts based on alert attributes (e.g., alert type identifier, tag identifier, description identifier, prioritization weight, etc.). In some embodiments, the graph-based model may be trained using graph neural networks on previous alert attributes associated with previous responder teams and users of the responder teams. In addition, a deep neural network (DNN) may be used in the present invention as the responder prediction machine learning model, wherein two or more responder prediction machine learning models may be used to output a response team prediction.

The term “response team prediction object” refers to a data object that describes the dataset generated by the responder prediction machine learning model for a corresponding alert. Response team predictions comprise a client identifier set associated with client devices for response team members having expertise that is appropriate to address a particular incident alert and/or a confidence score associated with the response team and response team members generated by the responder prediction machine learning model. In some embodiments, the response team prediction may be stored on the storage subsystem of the responder prediction server computing device.

The term “prioritization machine learning model” refers to a machine learning model that is configured to process the output of the responder prediction machine learning model such that the response team predictions are rearranged into a new order or sequence based on the associated prioritization weights assigned to each alert. The prioritization machine learning model may be configured to process the alerts and the response team predictions generated by the responder prediction machine learning model, in order to generate an operation sequence of an order to send out the response prediction alerts. The prioritization machine learning model may be trained using extracted data sets associated with past operation sequences (e.g., such as those operation sequences created by a human operator or those operation sequences defined in a separate data object defining a complex platform's specific policy). The prioritization machine learning model may be stored in a storage subsystem of the responder prediction server computing device such as the responder prediction model repository.

The term “prioritization weight identifier” refers to a descriptor of a data object associated with an alert that indicates the priority level for the alert. For example, an alert monitoring service tool identifier may comprise text string(s), numerical character(s), alphabetical character(s), alphanumeric code(s), ASCII character(s), a pointer, an IP address, a MAC address, a memory address, other unique identifier, or a combination thereof. In some circumstances, prior prioritization weight identifiers associated with prior alerts are processed by a machine learning model (e.g., the prioritization machine learning model) such that the machine learning model may be trained to identify a predicted or suggested prioritization weight identifier for a new alert. Past prioritization weight identifiers are associated with one or more prioritization weights generated from a previous predetermined time period (e.g., a high priority value, such as “P1,” may be associated with high priority alerts and lower priority values—such as “P2,” “P3,” and the like—may be associated with lower priority alerts). The prioritization weight identifier may be stored in the storage subsystem of the responder prediction server system, like the responder prediction model repository.

The term “responder prediction training corpus” refers to data objects that are configured to train the one or more machine learning models of the responder prediction server system. Such training corpuses (e.g., a first responder prediction training corpus, a second responder prediction training corpus, a third responder prediction training corpus, etc.) may comprise data objects generated by a complex platform over a predetermined time period, wherein the training corpus may embody previous data objects associated with previously generated alerts. For example, a responder prediction training corpus may comprise alert attributes extracted from alert related datasets generated within a predetermined time period (e.g., a year). Such training corpuses may be stored in the storage subsystem and the responder prediction service of the responder prediction server system such as the responder prediction model repository.

The term “predetermined time period” refers to a data object that describes a defined subset of time within a complex platform, such that the predetermined time period may be used to process only those alerts of the complex platform for that predetermined time period and any associated response teams generated from those alerts. In some embodiments, the predetermined time period may comprise multiple sets of predetermined time periods (e.g., a first predetermined time period, a second predetermined time period, a third predetermined time period, etc.). The predetermined time period may be stored in the storage subsystem of the responder prediction server system, such as the responder prediction model repository, or in the prediction service API of the responder prediction server system, such that alert related datasets may be generated based on the predetermined time period and the alert related datasets may have been stored in the storage subsystem of the responder prediction server system or in the prediction service API of the responder prediction server system.

The term “description identifier” refers to one or more items of data by which a description of the alert may be generated by the complex platform and captured by the alert monitoring service tool when extracting the alert. For example, a description identifier may comprise text string(s), numerical character(s), alphabetical character(s), alphanumeric code(s), ASCII character(s), a pointer, an IP address, a MAC address, a memory address, other unique identifier, or a combination thereof.

The term “log identifier” refers to one or more items of data by which a historical log of current alerts, past alerts, and responder teams may be captured by the alert monitoring service tool within a responder prediction server system (e.g., a log identifier may comprise data by which a log of actions taken on an alert are stored, which may include data of an alert being acknowledged by one or more responder teams, data of an alert being resolved by one or more responder teams, and/or data of one or more responder teams being added to an alert). For example, a log identifier may comprise text string(s), numerical character(s), alphabetical character(s), alphanumeric code(s), ASCII character(s), a pointer, an IP address, a MAC address, a memory address, other unique identifier, or a combination thereof.

The term “tag identifier” refers to one or more items of data b which an alert is tagged by the complex platform within a responder prediction server system. For example, a tag identifier may comprise text string(s), numerical character(s), alphabetical character(s), alphanumeric code(s), ASCII character(s), a pointer, an IP address, a MAC address, a memory address, other unique identifier, or a combination thereof.

The term “service identifier” refers to one or more items of data by which a service may be identified as associated with specific responder teams within a responder prediction server system. For example, a service identifier may comprise text string(s), numerical character(s), alphabetical character(s), alphanumeric code(s), ASCII character(s), a pointer, an IP address, a MAC address, a memory address, other unique identifier, or a combination thereof. In some embodiments, the service identifier may comprise data indicating the upstream and downstream services for each specific service associated with specific responder teams. In some embodiments, the service identifier may comprise service tier level data to indicate the importance of the service (e.g., the importance of the service to a company/user using the complex platform) for the user of the complex platform (e.g., monolithic platform and/or the service-oriented platform). In some embodiments, the service identifier may comprise data associated with other service identifiers which may indicate the number of impacted services from an alert of a specific service.

The term “response team identifier” refers to one or more items of data by which a response team may be identified within a responder prediction server system. For example, a response team identifier may comprise text string(s), numerical character(s), alphabetical character(s), alphanumeric code(s), ASCII character(s), a pointer, an IP address, a MAC address, a memory address, other unique identifier, or a combination thereof. The response team identifier may be used as a means to classify specific response teams for the response team prediction object.

The term “responder prediction service” refers to an application, program, platform, and/or software module configured for applying one or more responder prediction machine learning models to one or more alerts of a complex platform to generate a response team prediction object. The responder prediction service may be configured to access a responder prediction model repository to access updated or newly trained responder machine learning models.

The term “response team suggestion interface” refers to a graphical user interface configured to indicate a response team prediction based on the data objects and machine learning model(s) (e.g., responder prediction machine learning model and/or prioritization machine learning model) stored in the responder prediction model repository.

### DETAILED DESCRIPTION

### Example System Architecture

Systems, computer program products, and methods of the present invention may be embodied by any of a variety of devices. For example, the systems and methods of an example embodiment may be embodied by a networked computing device (e.g., an enterprise platform), such as a server or other network entity, configured to communicate with one or more devices, such as one or more client devices, one or more user devices, and one or more external services. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable computer, or any combination of the aforementioned devices.

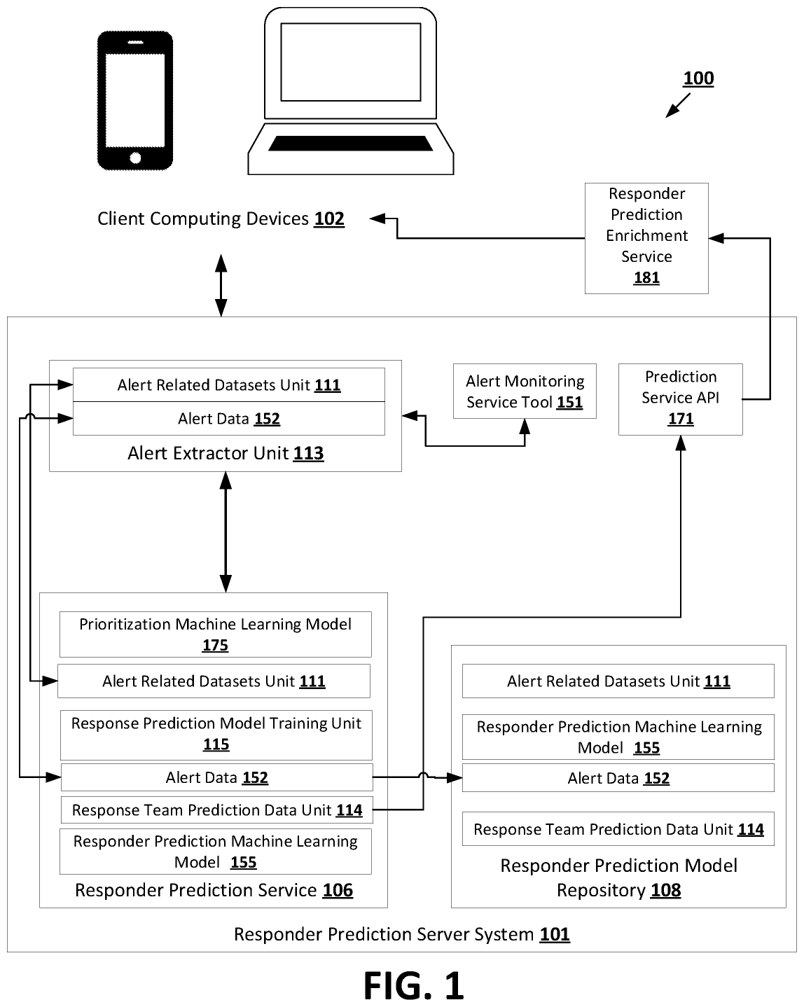

FIG. 1 depicts an exemplary architecture 100 for generating a response team prediction object associated with an alert. The architecture 100 includes one or more client computing devices 102 and a responder prediction server system 101. The responder prediction server system 101 is configured to store an alert extractor unit, a responder prediction model repository 108, and responder prediction service 106.

In some embodiments, the responder prediction server system 101 is configured to train one or more machine learning models to generate a response team prediction object based on one or more extracted alerts from the alert extractor unit 113 which may be transmitted from an alert monitoring service tool 151. The alert monitoring service tool 151 may be configured to collect one or more alert related datasets over a predetermined time period. An alert extractor unit 113 may be configured to extract the collected alert related dataset(s) and transmit said one or more alert related datasets to the responder prediction service 106 for processing and transmit the one or more alert related datasets to a responder prediction machine learning model 155 for training. The responder prediction service 106 may be configured to generate a response team prediction object—which may be aggregated in a response team prediction data unit 114 to be transmitted to a response prediction API 171—based on a responder prediction machine learning model 155, which is trained using a response prediction model training unit 115. The response prediction model training unit 115 may be configured to train one or more machine learning models (e.g., a responder prediction machine learning model 155 and/or a prioritization machine learning model 175) using an alert related datasets unit 111 received from an alert extractor unit 113. The prediction service API 171 may be configured to transmit the response team prediction data unit 114 to the a responder prediction enrichment service 181, which may enrich the response team object of the response team prediction data unit 114 with response team data (e.g., data associated with the response teams including email addresses, names, and other correspondence information). In some embodiments, the responder prediction enrichment service 181 may be housed within the client computing device 102 as an API, such that the prediction service API 171 may be in direct communication, over a network, with the client computing device 102 to transmit the response team prediction data unit 114. In some embodiments, the responder prediction enrichment service 181 of the client computing devices 102, may enrich the response team prediction object of the response team prediction data unit 114 and configure the GUI of the client computing device 102, wherein the content of the configured GUI (e.g., response team suggestion interface) of the client computing device 102 may comprise the response team prediction as a viewable, by a user of the client computing devices 102, configuration of the response team prediction object(s).

The responder prediction server system may be configured to provide a response team prediction object based on one or more extracted alerts (i.e., real-time alert data 152) from the alert extractor unit 113 which may be transmitted from an alert monitoring service tool 151. The extracted alert may be processed by a responder prediction machine learning model 155 trained by the response prediction model training unit 115. The responder prediction machine learning model 155 may be configured to output a response team prediction object which may be aggregated with other response team prediction objects associated with one or more alerts and stored in the response team prediction data unit 114. The response team prediction data unit 114 comprising the one or more response team prediction objects may be transmitted for storage to the responder prediction model repository 108 along with the associated alerts (e.g., alert data 152). The responder prediction model repository 108 may be configured to store at least the responder prediction machine learning model 155, the training data (e.g., the one or more alert related datasets) used by the responder prediction machine learning model 155, the alert data 152 (e.g., real-time alert data), and the response team prediction data unit 114 (e.g., the response team prediction object) generated by the responder prediction machine learning model processing the alert data.

The present invention may be further described by reference to FIGS. 1, 2, 3, 4, and 5. With respect to FIG. 1, a client computing device 102 may be provided to allow access by an end user to the responder prediction server system 101. The responder prediction server system 101 may comprise system modules such as an alert extractor unit 113, an alert monitoring service tool 151, a response prediction model training unit 115, a responder prediction service 106, a storage subsystem 108, and a prediction service API 171.

In some embodiments, an end user may access the responder prediction server system 101 using the client computing device 102. In some embodiments, an alert monitoring service tool 151 may receive an alert (e.g., alert data 152) when a complex platform is not running at peak performance, at regular predetermined intervals, or when one or more predetermined criteria or complex platform attributes reach predetermined levels. Such alerts may start the process herein described, of processing the alert through a responder prediction service 106 (e.g., a responder prediction machine learning model 155 and/or prioritization machine learning model 175) and returning a response team prediction object to a prediction service API 171.

With respect to training the response predication service 106 and its responder prediction machine learning model 155, a response prediction model training unit 115 may comprise an alert related datasets unit 111. The alert related datasets unit 111 may be used to create the first training corpus and/or a second training corpus which may both comprise a collected set of alert related datasets (e.g., alert related datasets extracted from specific predetermined time periods or alert related datasets extracted from specific response teams). The responder prediction machine learning model 155 may be trained iteratively based on the first training corpus and the second training corpus, and additional training corpuses generated as the machine learning models process one or more alerts. Each training corpus comprises alerts and associated response team prediction objects or manually determined response team routes for those alerts.

Once the responder prediction machine learning model 155 has been trained, an alert monitoring service tool 151 may extract alert data 152 from a complex platform (which may be associated with the responder prediction machine learning model's training). The alert data 152 may be processed by the responder prediction service 106 such that it is input into the responder prediction machine learning model 155. Once the responder prediction machine learning model 155 has processed the alert data 152, the responder prediction machine learning model 155 may output the correct response team prediction object. The response team prediction object of the response team prediction data unit 114 may be stored in the responder prediction model repository 108 along with the alert data extracted from the alert monitoring service tool 151.

In some embodiments, the response team prediction object(s) of the response team prediction data unit 114 may be sent back to the response prediction model training unit 115 to further train the responder prediction machine learning model 155 by updating the cache of alert related datasets unit 111. In some embodiments, the response team prediction object(s) of the response team prediction data unit 114 may be processed by the response prediction model training unit 115 and then pushed to a prediction service API 171, which may transmit the response team prediction object back to an end user or other user interface via the client computer device 102 after enriching the response team prediction object using the responder prediction enrichment service 181.

The client computing devices 102 and the responder prediction server system 101 may communicate over one or more networks. A network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, a network may include a cellular telephone, an 802.11, 802.16, 802.20, and/or WiMax network. Further, a network may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the page management system. In some embodiments, the protocol is a custom protocol of JavaScript Object Notation (JSON) objects sent via a Web Socket channel. In some embodiments, the protocol is JSON over RPC, JSON over REST/HTTP, and the like.

### Exemplary Document Collaboration Server Computing Device

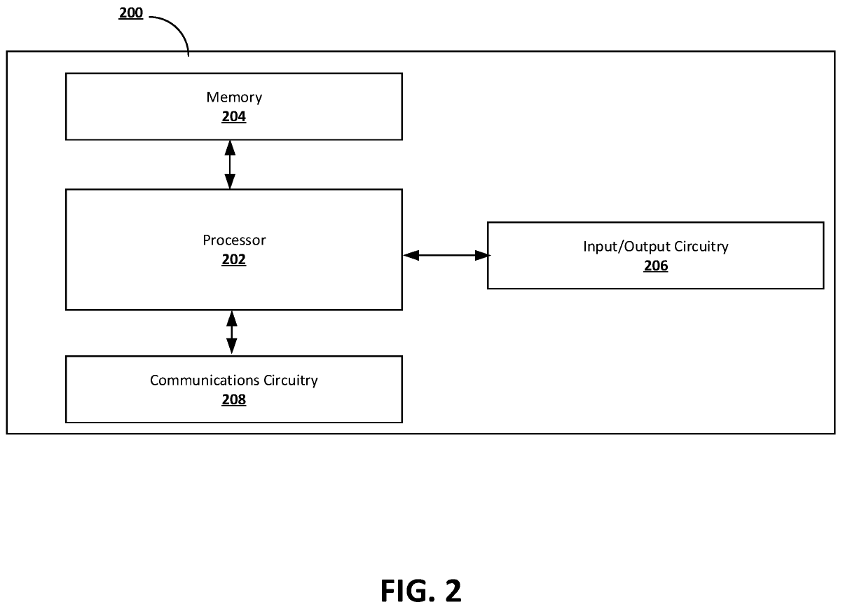

The responder prediction server system 101 may be embodied by one or more computing systems, such as apparatus 200 shown in FIG. 2. The apparatus 200 may include processor 202, memory 204, input/output circuitry 206, and communications circuitry 208. The apparatus 200 may be configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Exemplary Client Computing Device

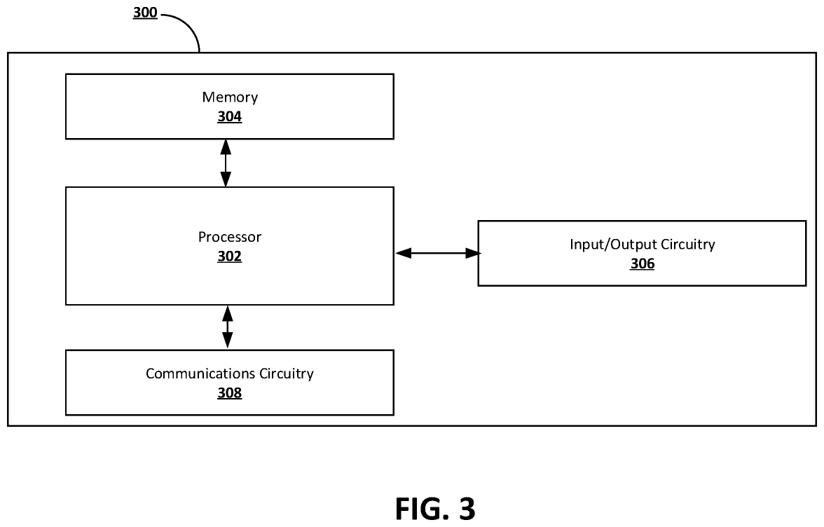

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Example Data Flows and Operations

### Example Model Training Operations

Provided below are techniques for training at least a responder prediction machine learning model. In some embodiments, similar techniques may be used to train a prioritization machine learning model which may be used in conjunction with the responder prediction machine learning model to generate a response team prediction object.

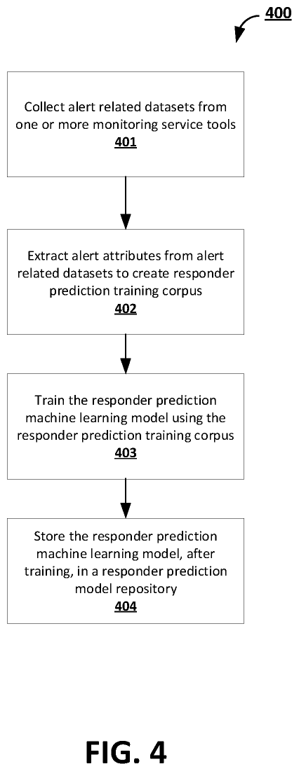

FIG. 4 is a flowchart diagram of an example process 400 for performing operations that are configured to train a responder prediction machine learning model. Via the various operations of process 400, the responder prediction server system 101 can train one or more responder prediction machine learning models to generate one or more response team prediction objects based on one or more alerts (real-time alerts) in an efficient manner without human interaction which may, in turn, be transmitted to a prediction service API 171 to generate a response team suggestion interface for transmission to a client computing device 102.

The process 400 begins at operation 401 when the alert extractor unit 113 extracts one or more alert related datasets from an alert monitoring service tool 151. The alert related datasets may be comprised within an alert related dataset unit 111. The alert related datasets may be extracted from a predetermined time period, such as a predetermined time period from a previous time period. For example, a predetermined time period may comprise 24 hours (such as the previous 24 hours leading up to the time of extraction of the alert related datasets), days (such as the previous week leading up to the time of extraction of the alert related datasets), months (such as a time period of the last month leading up to the time of extraction, the time period of the last 2 months, 3 months, 4 months, 5 months, 6 months, 7 months, 8 months, 9 months, 10 months, 11 months, 12 months, or any time period within those listed herein), years (such as a time period of the last year, last two years, three years leading up to the time of extraction of the alert related datasets, or any time within those listed herein). In some embodiments, the selected predetermined time period may be selected from any time in which the complex platform has been running (e.g., has comprised a data object, a program, source code, etc.). In some embodiments, the selected predetermined time period may be selected from any time in which an alert has been generated (either manually by a human operator or programmatically, such as by an Opsgenie® program created by Atlassian®) for the complex platform.

The alert related datasets extracted over this predetermined time period may comprise any alerts generated for the complex platform, including any alerts created by a human operator of the complex platform, a tenant of the complex platform (e.g., a consumer request to fix an issue identified by the tenant), a programmatic alerting program (e.g., Opsgenie® created by Atlassian®), or semi-programmatically (e.g., an alert generated by a program such as Opsgenie® by Atlassian®, which may only identify a source, wherein the alert is later identified by type by a human operator or tenant).

The alert related datasets extracted, or collected, by the alert extractor unit 113 may be transmitted to the responder prediction service 106. At step 402, the responder prediction service 106 may extract the alert attributes from the alert related datasets to create a responder prediction training corpus. The alert attributes extracted from the alert related datasets may comprise an alert identifier, a tag identifier, a description identifier, a log identifier, and a responder team identifier. In some embodiments, the alert attributes may further comprise a prioritization weight identifier and/or a service identifier.

The alert identifier associated with the alert attributes of an alert related dataset may classify specific types of alerts of the alert related dataset, based on the unique identifiers of the alert identifier. For example, the alert identifier may comprise CPU errors, storage errors (e.g., low storage availability), bug error preventing source code from running, front-end API errors, security threats, login errors, tenant, integration errors, data transfer errors, or any other errors known in the field. The alert identifier may be used within the alert related datasets to train the responder prediction machine learning model to predict an alert identifier of an alert processed at a future period of time, after training the responder prediction machine learning model. The type of alert identifier classified within an alert related dataset may be used by a machine learning model, such as the responder prediction machine learning model, to reduce the possible responder team predictions that the machine learning model may choose from. For instance, if an alert identifier for an alert related dataset comprises a classification of a CPU error, the responder prediction machine learning model may limit the possible response team prediction objects to only those teams that may work on a CPU error or those teams familiar with CPU errors. In some embodiments, each responder prediction machine learning model may process every alert attribute and a consensus of the responder prediction objects generated by the responder prediction machine learning model may be used to predict a responder prediction team.

In some embodiments, a plurality of responder prediction machine learning models may be clustered together to process sequentially or concurrently with each other responder prediction machine learning model to process specific alert attributes (e.g., a specific responder prediction machine learning model to process only one specific alert attribute). In some embodiments, the plurality of responder prediction machine learning models may comprise one or more aggregation layers after the training of the responder prediction machine learning models by one or more alert related datasets. In some embodiments, the aggregation layer may comprise one or more assigned weights and outputs from the responder prediction machine learning models, wherein the aggregation layer may take the input of one or more assigned weights and outputs from training of the responder prediction machine learning models and convert the one or more weights and outputs into a single feature space. In some embodiments, the aggregation layer may comprise a process to aggregate the weights and outputs of the responder prediction machine learning models by using a matrix dot product layer. In some embodiments, the aggregation layer may comprise a process to aggregate the weights and outputs of the responder prediction machine learning model by using a fully connected neural network layer that performs non-linear feature combination to place the weights and outputs into a common feature space. In some embodiments, the aggregation layer may comprise an output of one or more features (e.g., a common feature space may comprise the same number of cells—for example, the responder prediction machine learning models previously trained—as the input of the fully connected neural network) such that the dimension of the output feature is equal to the size of the aggregation layer. In some embodiments, the output feature may be used in the responder prediction machine learning models to predict the response team prediction object(s).

The service identifier associated with the alert attributes of an alert related dataset may classify the responder teams associated with the specific service, the upstream and downstream services for the specific service, the service tier level, and/or the number of other impacted services associated with the specific service. The service identifier may classify the responder team based on the type of error identified (e.g., alert identifier), and may further identify the service team (i.e., response team) associated with the service or type of error based on the alert. For example, if the alert identifier is classified as a CPU error, the service identifier may likewise classify only CPU responder teams. Based on the service identifier processed by the responder prediction machine learning model, the responder prediction machine learning model may limit the possible response team prediction objects to only those teams that may work on a CPU error or those teams familiar with CPU errors to select from for generating a responder team prediction object. Likewise, if the alert identifier is classified as bug error preventing source code from running, front-end API errors, security threats, login errors, tenant, integration errors, data transfer errors; the service identifier may also be classified as source code teams or those familiar with the source code, front-end API teams or those familiar with the front-end API, security teams or those familiar with the security of the complex platform, login and tenant supervising teams, or data integration teams or those familiar with data integration, respectively.

The response team identifier associated with the alert attributes of an alert related dataset may identify, or classify, a specific team or specific teams for each alert of the alert related datasets. The response team identifier may comprise data objects identifying specific teams, team members, correspondence data of each team member, or other specific identifying information of a responder team that previously attended to one or more alerts. The response team identifier may be processed by a responder prediction machine learning model for training so that the responder prediction machine learning model may generate the same or similar response team identifiers when processing an alert (e.g., a real-time alert). The alert attributes of the associated alert related datasets may be aggregated to generate a responder prediction training corpus.

At step 403, the responder prediction machine learning model may be trained using the training corpus of the associated alert related datasets. The responder prediction machine learning model may process each of the alert attributes (alert identifier, log identifier, description identifier, tag identifier, and responder team identifier) in order to identify relationships and patterns between each alert attribute. By identifying the patterns between each alert attribute, the responder prediction machine learning model may process an alert comprising one, two, or three of the alert attributes to determine a likely responder team identifier of an alert (i.e., real-time alert).

At step 404, the responder prediction machine learning model, after training with the training corpus, may be stored in a responder prediction model repository.

The responder prediction model repository 108 may be embodied as a data storage device such as a Network Attached Storage (NAS) device or devices, or as a separate database server or servers. The responder prediction model repository 108 may include information accessed or stored by the responder prediction service 106 to facilitate the operations of the responder prediction server system 101. The responder prediction model repository 108 may further store a plurality of machine learning models (e.g., the responder prediction machine learning model and/or the prioritization machine learning model), alert related datasets used to train the machine learning models (e.g., one or more training corpuses), alert data, response team data (e.g., identifying data associated with specific response teams or members of response teams) associated with the specific alert, or a response team prediction data unit comprising a database of possible response teams and identifying data associated with the possible response teams.

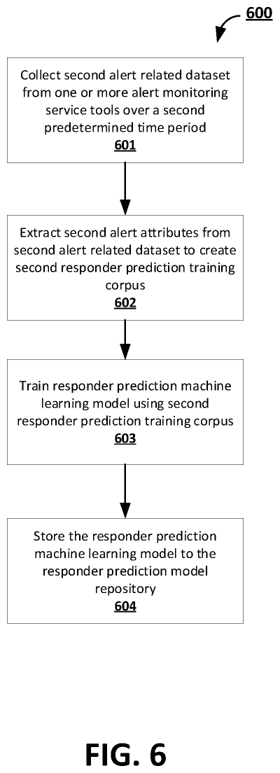

In some embodiments, the responder prediction machine learning model may be further trained using a second training corpus comprising a second alert related dataset, like the process depicted in FIG. 6, comprising process 600. The process of 600 begins at operation 601 with the responder prediction service 106 collecting a second alert related dataset from the alert extractor unit 113. At step 602, the responder prediction service 106 may extract a second set of alert attributes from the second alert related dataset in order to generate a second responder prediction training corpus. The second alert related dataset may be extracted based on an alert monitoring service tool (e.g., alert monitoring service tool 151) over a second predetermined time period. For instance, the alert monitoring service tool may only transmit alert related datasets associated with a specific second predetermined time period such as a predetermined time period taking place after the predetermined time period of FIG. 4. In some embodiments, the second predetermined time period may comprise a portion of the predetermined time period of FIG. 4 such that there is an overlap of time and data in the alert related dataset and the second alert related dataset. In some embodiments, the second predetermined time period may comprise a time period before the predetermined time period of FIG. 4, such that the second alert related dataset comprises older in time alert attributes which may not be as up-to-date as the predetermined time period used to train the responder prediction machine learning model of method 400. Similar to the predetermined time period of FIG. 4, the second predetermined time period may also comprise time such as days, months, years, or any time within those periods. In some embodiments, the second predetermined time period may comprise a time period after the predetermined time period of FIG. 4, such that the second alert related dataset comprises current alert attributes. In some embodiments, a user may select, via a GUI, the second predetermined time period from a plurality of possible predetermined time periods.

The second alert attributes of the of the second alert related datasets may be extracted by the responder prediction service 106 to generate the second responder prediction training corpus. Similar to the alert attributes of FIG. 4, the second alert attributes may also comprise an alert identifier, a description identifier, a log identifier, a tag identifier, and a responder team identifier for each associated alert related dataset of the second alert related datasets.

At step 603, the responder prediction machine learning model may be trained using the second responder prediction training corpus. At step 604, the responder prediction machine learning model may be stored in the responder prediction model repository. The responder prediction model repository may store the versions of the responder prediction machine learning model as separate versions and track updates to the responder prediction machine learning model as it is trained and stored to the responder prediction model repository.

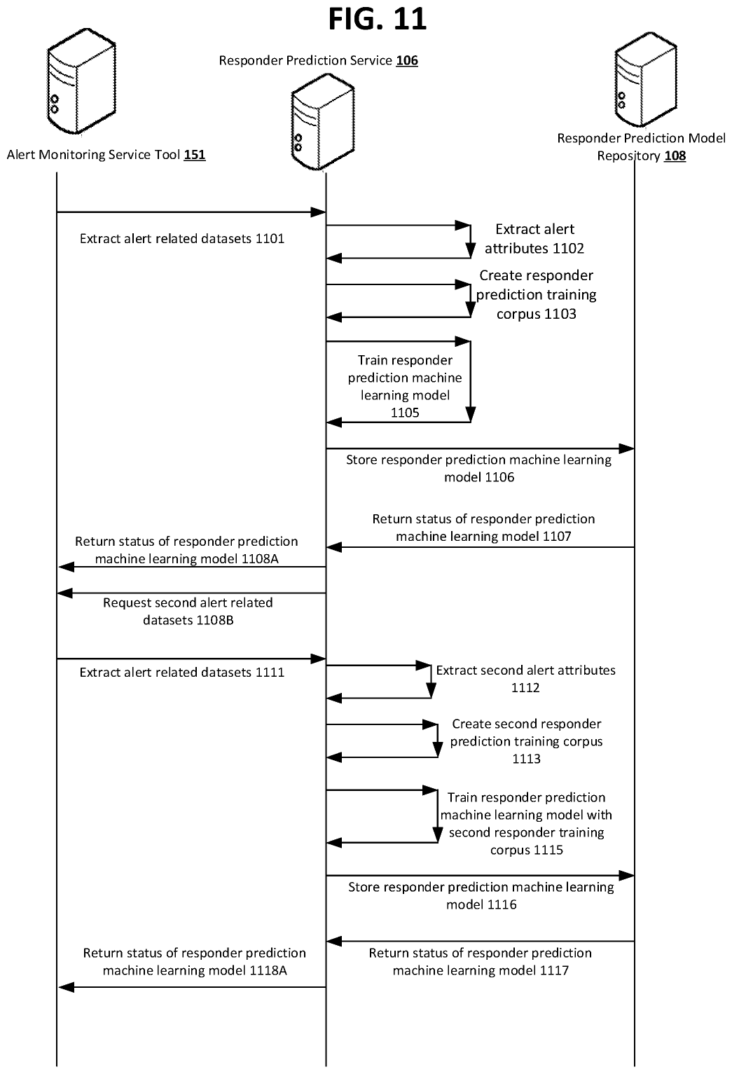

An example training operation may be shown in FIG. 11, wherein FIG. 11 provides example training operations performed on the responder prediction machine learning model. In some embodiments, alert related datasets may be extracted from an alert monitoring service tool 151 at 1101. The alert attributes of the alert related datasets may be extracted by a responder prediction service 106 at 1102. A responder prediction training corpus is generated at 1103 based on the extracted alert attributes. The responder prediction training corpus of 1103 is processed by the responder prediction machine learning model to train the responder prediction machine learning model at 1105. Once the responder prediction machine learning model has been trained with the responder prediction training corpus of 1103, the responder prediction machine learning model is stored in the responder prediction model repository 108 at 1106. In some embodiments, an acknowledgement of receipt by the responder prediction model repository 108 may be transmitted to the responder prediction service 106 at 1107.

In some embodiments, the responder prediction service 106 may return a status or acknowledgement of the responder prediction machine learning model to the monitoring service tool 151 at 1108A. In some embodiments, the responder prediction service 106 may request second alert related datasets at 1108B for further training of the responder prediction machine learning model. In some embodiments, the monitoring service tool 151 may automatically send the second alert related datasets to the responder prediction service 106 in combination with the alert related dataset of 1101. In some embodiments, the monitoring service tool 151 may automatically send the second alert related datasets to the responder prediction service 106 after the monitoring service tool 151 has received the status of the responder prediction machine learning model at 1108A.

In some embodiments, the monitoring service tool 151 may extract second alert related datasets and transmit the second alert related datasets to the responder prediction service 106 at 1111. In some embodiments, the responder prediction service 106 may extract second alert attributes from the second alert related datasets at 1112. Based on the second alert attributes, the responder prediction service 106 may generate a second responder prediction training corpus at 1113. The second responder prediction training corpus generated at 1113 by the responder prediction service 106 may be processed by the responder prediction machine learning model at 1115 in order to train the responder prediction machine learning model. In some embodiments, once the responder prediction machine learning model has been further trained by the second responder prediction machine learning model at 1115, the responder prediction machine learning model may be stored by the responder prediction model repository 108 at 1116. In some embodiments, once the responder prediction machine learning model has been stored at 1116, the responder prediction model repository 108 may return a status or acknowledgement of the responder prediction machine learning model to the responder prediction service 106 at 1117. In some embodiments, the responder prediction service 106 may, after receiving acknowledgement from the responder prediction model repository 108, return the status of the responder prediction machine learning model at 1118A. In some embodiments, the status of the responder prediction machine learning model may comprise an acknowledgement from the responder prediction model repository 108 that the responder prediction service 106 is performing and/or to indicate that an alert was processed successfully. In some embodiments, the status of the responder prediction machine learning model may indicate that the responder prediction service 106 is not performing and that an error was returned by one or more components (e.g., responder prediction machine learning model, prioritization machine learning model, response prediction model training unit, etc.) of the responder prediction service 106.

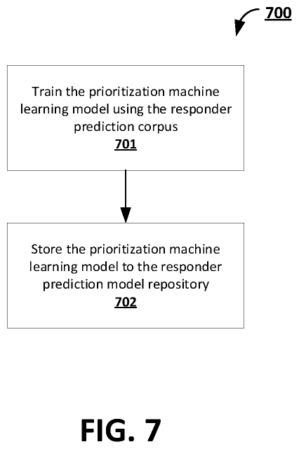

In some embodiments, a prioritization machine learning model 175 may be trained within the responder prediction server system 101. For example, and as shown in FIG. 7, a prioritization machine learning model 175 may be trained using responder prediction corpus of FIG. 4, wherein the responder prediction corpus comprising alert attributes further comprises an alert attribute of a prioritization weight identifier. The prioritization weight identifier of the responder prediction corpus used to train the prioritization machine learning model may comprise prioritization weights generated from a previous predetermined time period (e.g., the predetermined time period of the responder prediction training corpus of FIG. 4, or a different predetermined time period than the responder prediction training corpus of FIG. 4). The prioritization weight may be used to identify certain orders or sequences of processing the alerts through the responder prediction machine learning model 155 or the prioritization weight may be used to identify certain orders or sequences of transmitting the alerts to the prediction responder teams (i.e., order to transmitting the responder team prediction objects to the prediction service API and/or the client computing devices). For example, a higher prioritization weight (e.g., P1) associated with an alert processed by a responder prediction machine learning model may be processed before an alert comprising a lower processing weight (e.g., P2, P3, P4, etc.). Alternatively, the prioritization weights may be listed alternatively with P1 being the lowest, and the last alert processed, and any number above P1 comprising higher priority (e.g., P2 is higher than P1 but lower than P3, P3 is higher than P2 but lower than P4, P4 is higher than P3 but lower than P5, all the way up to PN).

In some embodiments, the prioritization machine learning model 175 may be trained based on a prioritization weight identifier comprised within an alert attribute of the responder prediction training corpus. The prioritization weight identifier may review each of the alerts associated with the alert related datasets of FIG. 4, further including the associated prioritization weight identifiers, and based on at least the associated prioritization weight identifiers and the other alert attributes (i.e., alert identifier, service identifier, tag identifier, log identifier, description identifier, and responder team identifier), the prioritization machine learning model 175 may be trained to learn associations between each of the alert attributes. For example, the prioritization machine learning model 175 may identify certain relationships of the alert attributes, for each of the alerts within an alert related dataset, to certain patterns between alert identifiers, service identifiers, tag identifiers, log identifiers, description identifiers, and/or responder team identifiers of the alert attributes and a prioritization weight identifier.

At step 702, the prioritization machine learning model 175 may be stored in the responder prediction model repository 108.

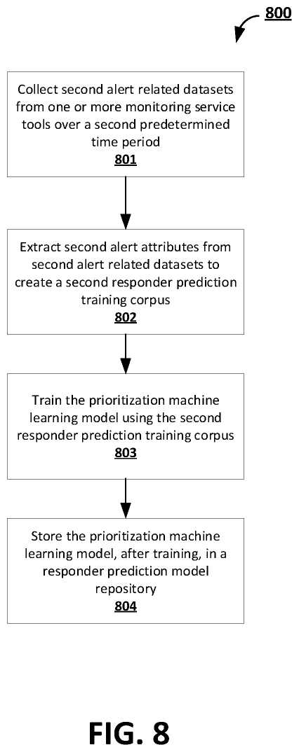

In some embodiments, the prioritization machine learning model 175 may be trained with a second alert related dataset comprising second alert attributes. For example, and as shown in FIG. 8, second alert related datasets may be extracted and collected from one or more monitoring service tools (e.g., 151) and transmitted to a responder prediction service 106, at step 801. The responder prediction service 106 may extract second alert attributes from the second alert related datasets in order to create a second responder prediction training corpus at step 802. At step 803, the prioritization machine learning model 175 may be trained using the second responder prediction training corpus. Once the prioritization machine learning model has been trained with the second responder prediction training corpus, the prioritization machine learning model 175 may be stored in the responder prediction model repository 108.

### Example Model Processing Operations

Provided below are technique for generating a response team prediction object from one or more responder prediction machine learning models and, optionally, one or more prioritization machine learning models.

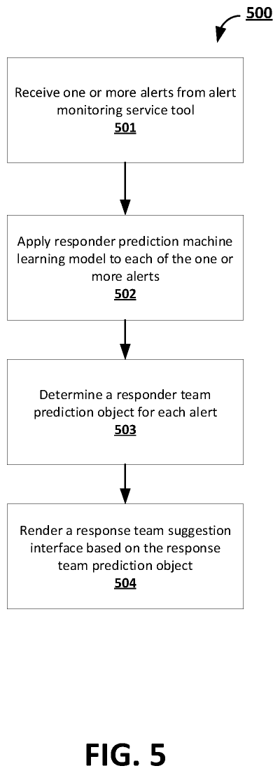

FIG. 5 is a flowchart diagram of an example process 500 for performing operations that are configured to determine a response team prediction object and rendering a response team suggestion interface based on said response team prediction object. Via the various operations of process 500, the responder prediction server system 101 may train one or more machine learning models, including a responder prediction machine learning model and/or a prioritization machine learning model. The responder prediction server system 101 may use the trained machine learning model(s) to process one or more alerts in order to generate a response team prediction object. Once a responder team prediction object has been generated, it may transmitted to a prediction service API 171, which may generate the response team prediction object and confidence score based on the responder team prediction object and transmit the response team prediction object and confidence score to the responder prediction enrichment service 181 or directly to the client computing device 102 which may comprise the responder prediction enrichment service 181. In some embodiments, the responder prediction enrichment service 181 may configure a GUI of the client computing device with response team identifier data (e.g., data comprising response team name, response team participants, client computing device data of response team users, etc.) and may render a GUI with the response team identifier data associated with the responder team prediction object. The GUI rendered by the responder prediction enrichment service 181 may comprise response team predictions as user-viewable configuration of the response team prediction object(s).

FIG. 5 depicts a flowchart diagram of an example process for determining a response team prediction object and rendering a response team suggestion interface based on an alert and the associated response team prediction object. The responder prediction server system 101 is configured to store an alert extractor unit, a response prediction model training unit 115, a responder prediction model repository 108, and responder prediction service 106.

In some embodiments, the responder prediction server system 101 is configured to train the responder prediction machine learning model 155 and prioritization machine learning model 175, which may both be used by the responder prediction service 106, to process one or more alerts to generate a response team prediction object, and stored in a responder prediction model repository 108. The alert monitoring service tool 151 may be configured to collect one or more alerts (e.g., real-time alerts). The alert monitoring service tool 151 may then transmit the collected one or more alerts to the responder prediction service 106, at step 501. The responder prediction machine learning model 155, which may be housed in the responder prediction service 106, may apply the responder prediction machine learning model 155 to the one or more alerts at step 502. At step 503 and based on the processing of the one or more alerts by the responder prediction machine learning model 155, a responder team prediction object for each alert may be determined.

At step 504, a response team suggestion interface based on the response team prediction object is rendered by the responder prediction service 106. In some embodiments, the response team suggestion interface may be transmitted to the client computing device 102 from a prediction service API in communication with the responder prediction service 106. In some embodiments, the prediction service API may do the rendering of the response team suggestion interface based on a transmitted response team prediction object from the responder prediction service 106.

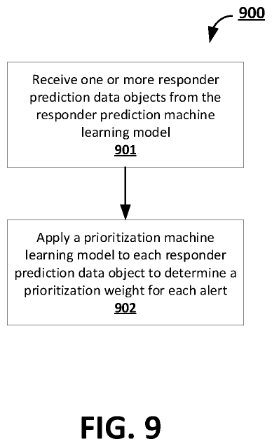

In some embodiments, a prioritization machine learning model 175 may also be applied to the one or more alerts to determine a prioritization associated with each alert. An example processing operation may be shown in FIG. 9, wherein FIG. 9 provides receiving one or more responder prediction data objects from the responder prediction machine learning model 155 at step 901. The one or more outputs may be applied to a prioritization machine learning model to determine a prioritization weight for each responder prediction data objects at step 902. The prioritization machine learning model may process the one or more responder prediction data objects after the responder prediction machine learning model, such that the output of the responder prediction machine learning model 155 (e.g., responder prediction data object) is processed by the prioritization machine learning model 175. In such an embodiment, the prioritization machine learning model may generate a rearranged sequence of the one or more response team prediction objects based on the one or more alerts, wherein if an alert associated with the response team prediction object is assigned a higher priority (e.g., P1), then the response team prediction object may be rearranged to the top of the sequence of the one or more response team prediction objects and transmitted to the prediction service API 171 and subsequently to the client computing device 102 (or the responder prediction enrichment service 181), as a response team suggestion interface comprising a response team prediction, before other response team prediction objects of lower priority are transmitted to the prediction service API 171. Alternatively, if the response team prediction object is assigned a lower priority (e.g., P2, P3, P4, etc.), then the response team prediction object may be rearranged to the bottom of the sequence of the one or more response team prediction objects and transmitted to the prediction service API 171 and subsequently to the client computing device (or the responder prediction enrichment service 181), as the response team suggestion interface comprising a response team prediction, after other response team prediction objects of higher priority have been transmitted to the prediction service API 171.

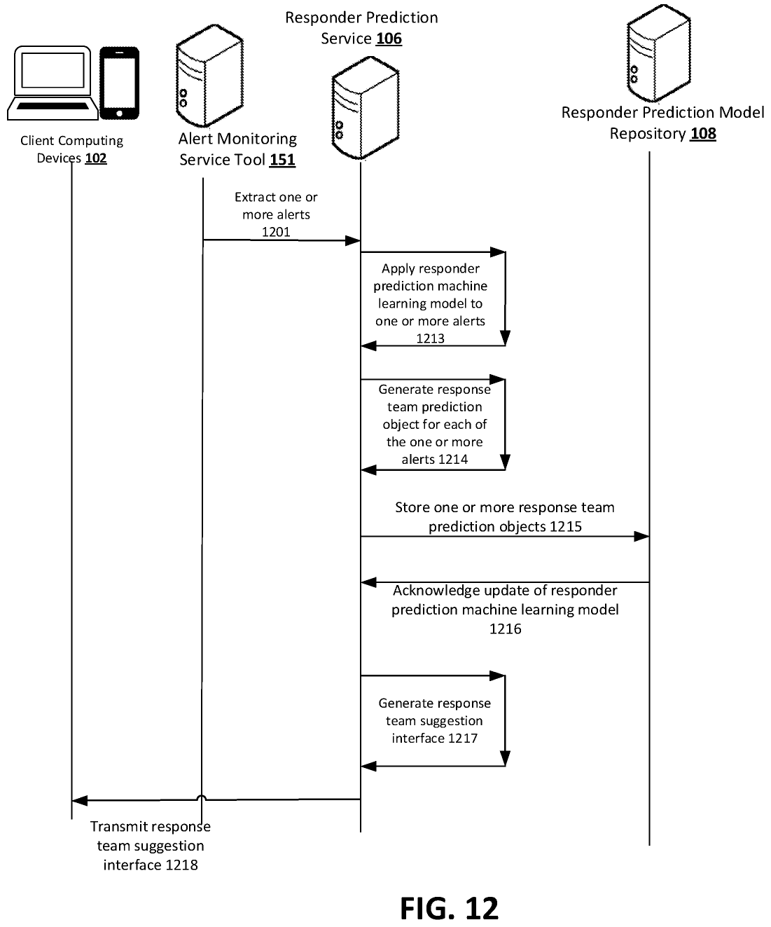

An example processing operation to generate a response team prediction object and rendering a response team suggestion interface may be shown in FIG. 12, wherein FIG. 12 provides example processing operations performed on the one or more alerts received from the alert monitoring service tool 151. In some embodiments, one or more alerts are extracted by an alert monitoring service tool 151 and transmitted to the responder prediction service 106 at 1201. The one or more alerts are applied to a responder prediction machine learning model at 1213 to generate one or more response team prediction objects, at 1213 and 1214, respectively. In some embodiments, a prioritization machine learning model 175 may be applied to the one or more alerts to generate a prioritization weight of each of the one or more alerts before the one or more alerts are processed by the responder prediction machine learning model 155. In some embodiments, a prioritization machine learning model 175 may be applied to the one or more response team prediction objects generated from the responder prediction machine learning model 155 to generate a prioritization weight of each of the response team prediction objects.

In some embodiments, the responder prediction service 106 may store the one or more response team prediction objects in the responder prediction model repository 108, at 1215. The one or more response team prediction objects stored in the responder prediction model repository 108 may comprise a prioritization weight generated by a prioritization machine learning model 175. In some embodiments, the prioritization weights of the associated response team prediction objects may determine a sequence of storing the one or more response team prediction objects in the responder prediction model repository 108 (e.g., a response team prediction object with a higher prioritization weight may be stored before a response team prediction object with a lower prioritization weight).

In some embodiments, the responder prediction model repository 108 may transmit an acknowledgment of the update of the responder prediction machine learning model stored in the responder prediction model repository 108 at 1216. In some embodiments, the responder prediction model repository 108 may transmit an acknowledgement of an update of the prioritization machine learning model stored in the responder prediction model repository 108 to the responder prediction service 106.

In some embodiments, the responder prediction service 106 may generate a response team suggestion interface at 1217 to for rendering on a client computing device 102. In some embodiments, the responder prediction service 106 may generate the response team suggestion interface at 1217 and transmit the response team suggestion interface to the client computing device 102 at 1218. In some embodiments, the responder prediction service 106 may generate the response team suggestion interface at 1217 and transmit the response team suggestion interface to a prediction service API 171 that is in communication with a client computing device 102. In some embodiments, the responder prediction service 106 may generate the response team prediction object for each of the one or more alerts at 1214, and after transmitting the one or more response team prediction objects to the responder prediction model repository 108 at 1215 and receiving acknowledgement at 1216, the responder prediction service 106 may transmit the one or more response team prediction objects to the prediction service API 171 to generate the response team suggestion interface. In some embodiments, the prediction service API 171 may transmit the generated response team suggestion interface to the client computing device 102. In some embodiments, feedback from the client computing device may be transmitted back to the responder prediction service 106 as a binary indication that the response team prediction objects generated by the responder prediction service 106 was correct or incorrect (e.g., a user of the client device may select a “button” configured on the GUI to indicate whether the response team prediction was correct—check—or incorrect—cross-mark (“X”)). A person of skill in the art will understand that any feedback function or configured GUI comprising a feedback interface may be used by the invention described herein to receive user interaction data of the performance of the responder prediction service 106 and that the feedback function is not limited “buttons” comprising checks or cross-marks (e.g., “X”).

### Example User Interface Configurations

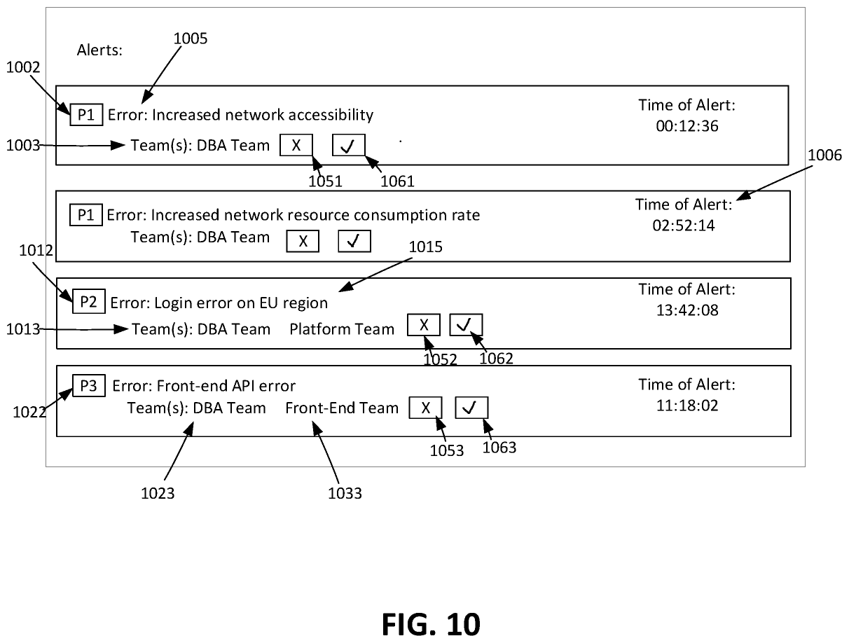

FIG. 10 illustrates an example GUI configured on a client computing device 102 in accordance with a response team suggestion interface. With respect to FIG. 10, a GUI of a client computing device 102 may be configured to indicate one or more response team predictions in the response team suggestion interface. The response team prediction(s) in the response team suggestion interface may comprise indications of an alert, or error, type at 1005 and 1015, wherein 1005 describes the type of effort as “increased network accessibility” and 1015 describes the alert as a “login error” and further describes the region of the alert as the “EU region.”). In some embodiments, the response team suggestion interface may further comprise the identification of the response team(s) for each of the one or more response team predictions (e.g., 1003, 1013, 1023, 1033). In some embodiments, the identification of the response team(s) for each of the one or more response team predictions may comprise one or more response teams that may be notified of the alert (e.g., 1013 comprises both the “DBA Team” and the “Platform Team” as response teams; 1023 and 1033 both identify a “DBA Team” and “Front-End Team”, respectively, for the associated response team prediction). In some embodiments, the GUI may be configured on the client computing device 102 to comprise buttons for user feedback for each of the one or more response team predictions, wherein the buttons may comprise a positive indication of user feedback that the response team prediction is correct (e.g., a “check” as shown at 1061, 1062, and 1063) or negative indication of user feedback that the response team prediction is incorrect (e.g., an “X” as shown at 1051, 1052, and 1053). By indicating that a response team prediction is correct or incorrect via GUI (e.g., through selection of the check or “X”) the client computing device 102 may transmit the feedback to the responder prediction server system 101 for further training of the one or more machine learning models within the responder prediction service 106 (e.g., responder prediction machine learning model 155 and/or prioritization machine learning model 175).

In some embodiments, the response team prediction of the response team suggestion interface may comprise a temporal indication (e.g., 1006) of when the alert was detected in the complex platform.

In some embodiments, the GUI of the client computing device 102 may be configured to indicate the prioritization weight (1002, 1012, 1022) for each of the response team predictions within the response team suggestion interface. In some embodiments, the response team predictions may be organized based on the associated prioritization weights. For example, the response team predictions of FIG. 10 are organized with the highest prioritization weight 1002 (“P1”) at the top of the GUI and the lowest prioritization weight 1022 (“P3”) at the bottom of the GUI.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. Thus, for example, references to “an image” includes a combination of two or more images and references to “a graphic” includes different types and/or combinations of graphics.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate form the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

That which is claimed is:

1. A computer-implemented method of training a responder prediction machine learning model for generating response team predictions comprising:
collecting alert related datasets originating from one or more alert monitoring service tools over a predetermined time period;
extracting alert attributes from the alert related datasets to create a responder prediction training corpus, wherein the alert attributes comprise an alert identifier, a tag identifier, a log identifier, a description identifier, and a responder team identifier;
training the responder prediction machine learning model using the responder prediction training corpus; and
storing the responder prediction machine learning model following training to a responder prediction model repository, wherein the responder prediction model repository is accessible by a responder prediction service.

2. The computer-implemented method of claim 1 further comprising:
collecting second alert related datasets originating from the one or more alert monitoring service tools over a second predetermined time period;
extracting second alert attributes from the second alert related datasets to create a second responder prediction training corpus;
training the responder prediction machine learning model using the second responder prediction training corpus; and
storing the responder prediction machine learning model following training to the responder prediction model repository.

3. The computer-implemented method of claim 1, further comprising:
receiving one or more alerts from an alert monitoring service tool; and
applying, for each of the one or more alerts, a responder prediction machine learning model to determine a response team prediction object for each alert.

4. The computer-implemented method of claim 3, further comprising applying a score to each response team prediction object of the one or more alerts.

5. The computer-implemented method of claim 4, further comprising determining the score of the response team prediction object using at least one of a user input or a closing alert, and wherein the score is calculated by comparing the response team prediction object with at least one of the user input or the closing alert.

6. The computer-implemented method of claim 4, further comprising training the responder prediction machine learning model in a subsequent stage using the score associated with each response team prediction object of the one or more alerts.

7. The computer-implemented method of claim 6, wherein the score is applied to the responder prediction machine learning model to determine one or more future response team prediction objects.

8. The computer-implemented method of claim 1, further comprising training a prioritization machine learning model comprising:
training the prioritization machine learning model using the responder prediction training corpus, the alert attributes of the responder prediction training corpus further comprising a prioritization weight identifier; and
storing the prioritization machine learning model following training to the responder prediction model repository, wherein the responder prediction model repository is accessible by a responder prediction service.

9. The computer-implemented method of claim 8, further comprising:
collecting second alert related datasets originating from the one or more alert monitoring service tools over a second predetermined time period;
extracting second alert attributes from the second alert related datasets to create a second responder prediction training corpus;
training the prioritization machine learning model using the second responder prediction training corpus; and
storing the prioritization machine learning model following training to the responder prediction model repository.

10. An apparatus for generating a response team prediction associated with one or more alerts, the apparatus comprising at least one processor and at least one memory including program code, the at least one memory and program code configured to, with the processor, cause the apparatus to at least:
receive one or more alerts from an alert monitoring service tool;
for each of the one or more alerts, apply a responder prediction machine learning model to determine a response team prediction object for each alert; and
cause rendering of a response team suggestion interface based on the response team prediction object.

11. The apparatus of claim 10, wherein the response team prediction object is transmitted to a prediction service API that is configured to indicate an alert notification comprising at least one of the response team prediction, a dataset of routing information associated with at least a client identifier set for the response team prediction, or the alert associated with the response team prediction.

12. The apparatus of claim 10, wherein the responder prediction machine learning model comprises a pre-training with an extracted alert related dataset associated with a complex platform.

13. The apparatus of claim 12, wherein the extracted alert related dataset comprises data extracted from a predetermined time period.

14. The apparatus of claim 10, wherein the at least one memory and program code configured to, with the processor, cause the apparatus to at least:
receive one or more alerts from an alert monitoring service tool; and
for each of the one or more alerts, apply a prioritization machine learning model to determine a prioritization weight for each alert.

15. The apparatus of claim 14, wherein an operation sequence of processing for the responder prediction machine learning model is applied to the one or more alerts based on the prioritization weight for each of the one or more alerts.

16. The apparatus of claim 14, wherein an operation sequence for determining the response team prediction object is applied to the alerts based on the prioritization weight for each alert.

17. The apparatus of claim 14, wherein an operation sequence for the rendering of the response team suggestion interface based on the response team prediction object is based on the prioritization weight for each of the one or more alerts used to generate the response team prediction object.

18. The apparatus of claim 10, wherein a score is determined by the response team prediction associated with an alert and at least one of user input or a closing alert.

19. The apparatus of claim 18, wherein the score is applied to the responder prediction machine learning model to determine one or more future response team predictions.
